(19) United States
(12) Patent Application Publication
(10) Pub. No.: US 2009/0002795 A1
(43) Pub. Date: Jan. 1, 2009

(54) MICROMIRROR DEVICE

(75) Inventor: Tomoyuki HATAKEYAMA, Hachioji-shi (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/145,575

(22) Filed: Jun. 25, 2008

(30) Foreign Application Priority Data
Jun. 29, 2007 (JP) 2007-173150

(51) Int. Cl. G02B 26/08

(52) U.S. Cl. 359/223

(57) ABSTRACT

A micromirror device includes a micromirror chip, an electrode substrate, and an intermediate spacer sandwiched between the micromirror chip and the electrode substrate and having substantially the same shape as that of the micromirror chip, the intermediate spacer inhibiting the mirror support portion from being deformed by the moving movable mirror portion. The micromirror chip, the electrode substrate, and the intermediate spacer are arranged and stacked in a thickness direction. The intermediate spacer has an opening located substantially in the center of the intermediate spacer and a plate-like fixed member having a plurality of through-holes disposed around the periphery of the opening. A junction member is melted by desired heating and weighting and inserted and placed in each of the through-holes. When melted, the junction member joins the micromirror chip to the electrode substrate.

### CROSS-REFERENCE TO RELATED APPLICATIONS

This application is based upon and claims the benefit of priority from prior Japanese Patent Application No. 2007-173150, filed Jun. 29, 2007, the entire contents of which are incorporated herein by reference.

### BACKGROUND OF THE INVENTION

1. Field of the Invention

The present invention relates to a micromirror device having a movable portion.

2. Description of the Related Art

For example, Jpn. Pat. Appln. KOKAI Publication No. 2005-316043 discloses a microdevice having a movable portion. Jpn. Pat. Appln. KOKAI Publication No. 2005-316043 will be described in brief with reference to FIGS. 10A to 10C. As shown in FIGS. 10A to 10C, in this microdevice, the amount by which solder bumps 102 to be melted are deformed is controlled. This adjusts the distance (hereinafter referred to as the gap) between a micromirror chip 104 and an electrode-side substrate 106 such that a desired gap is maintained.

The micromirror chip 104 has a fixed frame 110 connected to a movable mirror portion 108. The fixed frame 110 is connected to the movable mirror portion 108 by hinges 109. The fixed frame 110 and the electrode-side substrate 106 are only locally fixed to each other by the solder bumps 102. The movable mirror portion 108 is movable around the hinges 109 by means of electrostatic attraction or the like.

### BRIEF SUMMARY OF THE INVENTION

The present invention has been made in view of these circumstances. An object of the present invention is to provide a micromirror device that can inhibit a variation in gap even with movement of the movable mirror portion.

To accomplish the object, the present invention provides a micromirror device comprising a first member having a movable portion and a movable portion support portion which supports the movable portion, a second member having a driving electrode to which a driving voltage allowing the movable portion to move is applied, an electrically conducting portion which electrically connects the first member and the second member together for electrical conduction, a spacer portion which holds a desired distance between the first member and the second member, and an intermediate member having an inhibiting portion which inhibits the first member from being deformed, the intermediate member being sandwiched between the first member and second member.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a micromirror chip is according to a first embodiment of the present invention;

FIG. 2 is an exploded perspective view of the micromirror device according to the first embodiment of the present invention;

FIG. 3 is a sectional view of the micromirror device shown in FIG. 2, taken along line A-A in FIG. 2, specifically, the view showing a junction in the micromirror device;

FIG. 4A is a diagram showing positions where a plurality of movable mirror portions are arranged;

FIG. 4B is a diagram showing positions where the plurality of movable mirror portions are arranged;

FIG. 5 is an exploded perspective view of a micromirror device according to a second embodiment of the present invention;

FIG. 6 is a sectional view of the micromirror device shown in FIG. 5, taken along line B-B in FIG. 5, specifically, the view showing a junction in the micromirror device;

FIG. 7 is a schematic perspective view of a frame member according to a third embodiment of the present invention;

FIG. 8 is an exploded perspective view of a micromirror device according to a third embodiment of the present invention;

FIG. 9 is a sectional view of the micromirror device shown in FIG. 8, taken along line C-C in FIG. 8, specifically, the view showing a junction in the micromirror device;

FIG. 10A is a perspective view showing the structure of a conventional microdevice having a movable portion;

FIG. 10B is a side view showing the structure of the conventional microdevice having the movable portion; and

FIG. 10C is a side view showing the structure of the conventional microdevice having the movable portion.

### DETAILED DESCRIPTION OF THE INVENTION

Embodiments of the present invention will be described below with reference to the drawings.

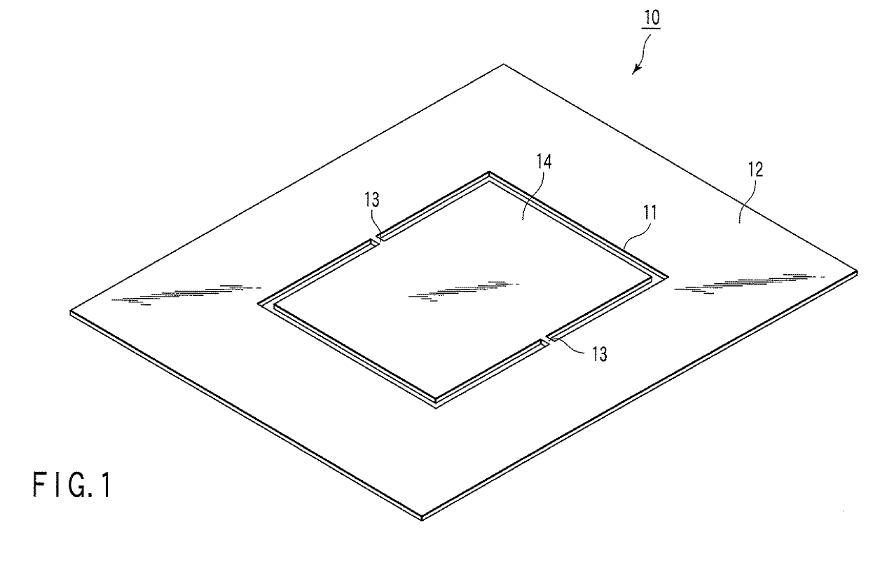

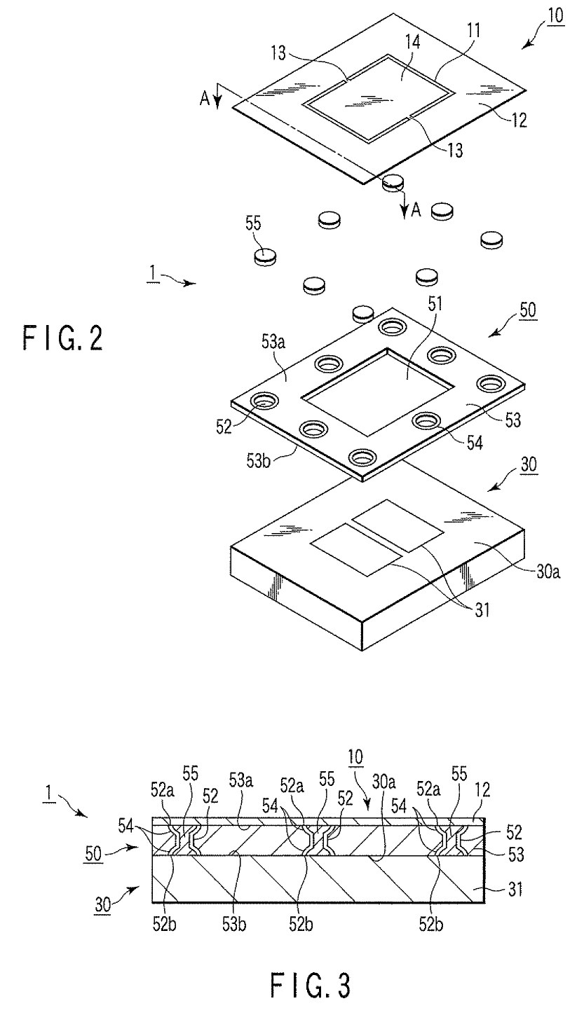

A first embodiment of the present invention will be described with reference to FIGS. 1 to 3. FIG. 1 is a perspective view of a micromirror chip according to a first embodiment of the present invention. FIG. 2 is an exploded perspective view of the micromirror device according to the first embodiment of the present invention. FIG. 3 is a sectional view of the micromirror device shown in FIG. 2, taken along line A-A in FIG. 2, specifically, the view showing a junction in the micromirror device.

As shown in FIG. 1, a micromirror chip 10 that is a first member has a mirror support portion (movable portion support portion) 12 with a first opening (hereinafter referred to as an opening 11), and a movable mirror portion 14 connectively supported in the mirror support portion 12 at the opening 11 via hinge portions 13 corresponding a support main body portion.

The mirror support portion 12 is a substantial plane and is shaped like, for example, a rectangle. The mirror support portion 12 is a mirror support member that supports the movable mirror portion 14 at the opening 11 by means of the hinge portions 13. The opening 11 is located substantially in the center of the mirror support portion 12. The opening 11 suitably has a shape similar to the external shape of the mirror support portion 12, or a rectangular shape. The movable mirror portion 14 is a movable portion that can be moved (tilted) by electrostatic attraction described below, using the hinge portions 13 as support points.

The micromirror chip 10, the mirror support portion 12, the hinge portions 13, and the movable mirror portion 14 have substantially the same thickness, for example, a thickness of about 10 μm to about 20 μm.

As shown in FIG. 2, the micromirror device 1 has the micromirror chip 10, shown in FIG. 1, an electrode substrate 30 that is a second member having driving electrodes 31 to which a driving voltage making the movable mirror portion 14 movable is applied, and an intermediate spacer 50 that is an intermediate member sandwiched between the micromirror chip 10 and the electrode substrate 30 and having substantially the same shape as that of the micromirror chip 10, the intermediate spacer 50 inhibiting the mirror support portion 12 from being displaced (deformed) in a vertical direction by the moving movable mirror portion 14. The micromirror chip 10, the electrode substrate 30, and the intermediate spacer 50 are arranged and stacked in a thickness direction. Surfaces of the micromirror chip 10, the electrode substrate 30, and the intermediate spacer 50 which lie opposite one another are substantially flat.

In the electrode substrate 30, the driving electrodes 31 are disposed opposite the movable mirror portion 14. The driving electrode 31 is disposed on a surface 30a that is flat. The surface 30a has substantially the same area as that of a bottom surface 53b or is larger than the bottom surface 53b.

The intermediate spacer 50 has a fixed member 53 that is a plate-like member and a junction member 55 shown in FIG. 3 and joining the micromirror chip 10 to the electrode substrate 30.

The fixing member 53 has an opening 51 located substantially in the center of the fixing member 53 and opposite the opening 11 and a plurality of through-holes 52 disposed around the periphery of the opening 51 and penetrating the fixed member 53 in the thickness direction of the fixed member 53. In the present embodiment, the eight through-holes 52 are disposed in the fixed member 53.

The fixed member 53 has substantially the same shape as that of the mirror support portion 12. The opening 51 has substantially the same shape as that of the opening 11. The fixed member 53 has a desired thickness corresponding to the mirror support portion 12. The thickness of the fixed member 53 is, for example, about 10 μm to about 20 μm as described above and is equal to the gap between the micromirror chip 10 and the electrode substrate 30. Thus, the fixed member 53 includes a spacer portion that holds the desired distance between the micromirror chip 10 and the electrode substrate 30.

A top surface 53a and the bottom surface 53b of the fixing member 53 are flat. When the micromirror chip 10, the electrode substrate 30, and the intermediate spacer 50 are stacked, the top surface 53a touches on the mirror support portion 12. The bottom surface 53b touches on the surface 30a of the electrode substrate 30. The fixing member 53 is formed of a material having a coefficient of thermal expansion close to those of the micromirror chip 10 and the electrode substrate 30.

In the fixed member 53, the through-holes 52 are formed at desired distances from one another. A junction member 55 is inserted and placed in each of the through-holes 52; the junction member 55 is conductive, has substantially the same height as the fixed member 53, and is melted by desired heating and weighting. The junction member 55 includes, for example, solder. When melted, the junction member 55 placed in each of the through-holes 52 mechanically joins the micromirror chip 10 and the intermediate spacer 50 (mirror support portion 12 and fixed member 53) together and also mechanically joins the intermediate spacer 50 and the electrode substrate 30 (fixed member 53 and surface 30a) together. Thus, the junction member 55 joins the micromirror chip 10 and the electrode substrate 30 together. At this time, the junction member 55 electrically connects the micromirror chip 10 and the electrode substrate 30 together so that current is conducted through the micromirror chip 10 and the electrode substrate 30. When the micromirror chip 10 and the intermediate spacer 50 are joined together, the junction member 55 inhibits the mirror support portion 12 from being deformed by the movable mirror portion 14, which can be moved by electrostatic attraction.

Thus, the intermediate spacer 50 (fixed member 53 and junction member 55) is an inhibiting portion that inhibits the mirror support portion 12 from being deformed. Furthermore, as described above, the junction member 55 is conductive and electrically connects the micromirror chip 10 and the electrode substrate 30 together. Thus, the junction member 55 is an electrically conducting portion.

For example, a tapered groove 54 that is a clearance groove is formed on surfaces of each of the through-holes 52 which lie opposite the micromirror chip 10 and the electrode substrate 30, that is, a top surface 52a of the through-hole 52 which lies opposite the micromirror chip 10 and a bottom surface 52b of the through-hole 52 which lies opposite the electrode substrate 30. The melted junction member 55 partly flows to the groove 54. The groove 54 prevents the flowing junction member 55 from spreading to the top surface 53a and bottom surface 53b of the fixed member 53 through the corresponding through-hole 52.

Now, the effects of the present embodiment will be described.

The bottom surface 53b touches on the surface 30a, and the intermediate spacer 50 is placed on the electrode substrate 30. The junction member 55 is inserted and placed in each of the through-holes 52. The micromirror chip 10 (mirror support portion 12) touches on the top surface 53a and is placed on the intermediate spacer 50. When the micromirror chip 10, the electrode substrate 30, and the intermediate spacer 50 are thus stacked together, the movable mirror portion 14 lies opposite the driving electrodes 31 via the opening 51.

When the junction member 55 is melted by the desired heating and weighting, the melted junction member 55 joins the micromirror chip 10 and the electrode substrate 30 (mirror support portion 12 and surface 30a) together. In FIG. 3, the intermediate spacer 50 and the junction member 55 are not joined together by the junction member 55. However, the intermediate spacer 50 and the junction member 55 may be joined together by the junction member 55.

When a desired voltage is applied to the driving electrodes 31, electrostatic attraction is produced between the movable mirror portion 14 and the driving electrodes 31. The movable mirror portion 14 is tilted through a desired angle by the electrostatic attraction using the hinge portions 13 as support points. In this case, stress is produced in the mirror support portion 12 via the hinge portions 13. That is, the tilt of the movable mirror portion 14 exerts pressure on the mirror support portion 12 via the hinge portions 13. However, the mirror support portion 12, joined to the fixed member 53 by the junction member 55, is inhibited from being displaced in the vertical direction. Consequently, a variation in gap is inhibited.

Thus, in the present embodiment, the intermediate spacer 50 is sandwiched between the micromirror chip 10 and the electrode substrate 30 to inhibit the mirror support portion 12 from being deformed. The micromirror chip 10 and the electrode substrate 30 are joined together by the junction member 55. In this case, the micromirror chip 10, joined to the fixed member 53 by the junction member 55, is inhibited from being displaced in the vertical direction even with movement of the movable mirror portion 14. Thus, the present embodiment can inhibit a variation in gap.

Furthermore, since the micromirror chip 10 is inhibited from being displaced in the vertical direction even with the movement of the movable mirror portion 14, the present embodiment allows the gap to be determined on the basis of the thickness of the intermediate spacer 50 (fixed member 53). That is, adjustment of the thickness of the intermediate spacer 50 (fixed member 53) adjusts the gap.

Furthermore, in the present embodiment, the groove 54 prevents the melted junction member 55 from spreading to the top surface 53a and the bottom surface 53b. Thus, the top surface 53a and the bottom surface 53b are always flat. The micromirror chip 10 and the intermediate spacer 50 are tightly joined together without creating any gap. The intermediate spacer 50 and the electrode substrate 30 are also tightly joined together without creating any gap. The present embodiment can thus inhibit a variation in gap caused by the gap between micromirror chip 10 and the intermediate spacer 50 or between the intermediate spacer 50 and the electrode substrate 30.

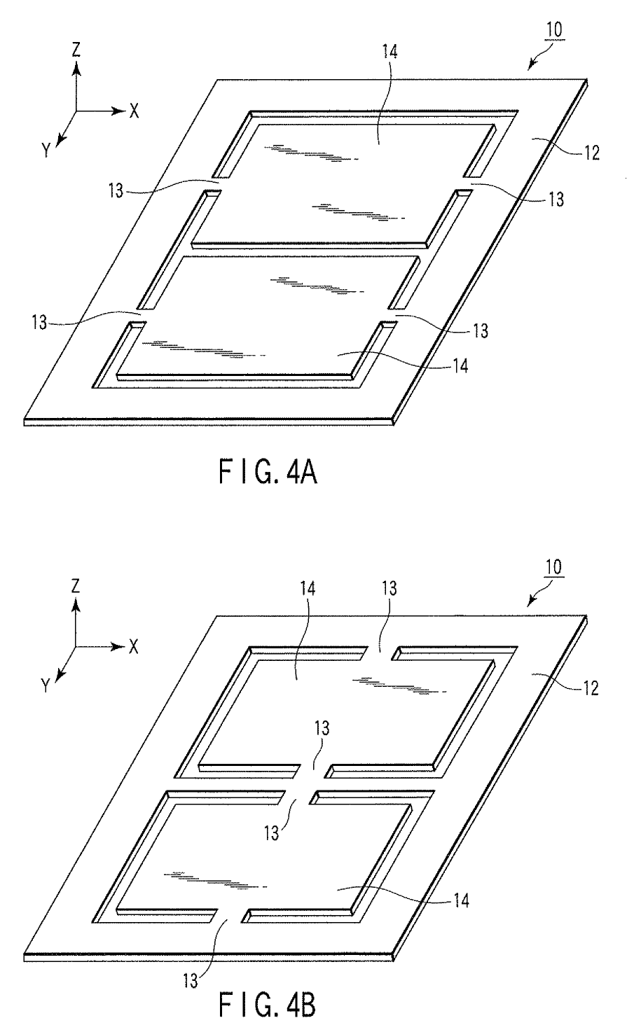

According to the present embodiment, the number of movable mirror portions 14 need not be limited to one. The micromirror chip 10 may have a plurality of the movable mirror portions 14 disposed, for example, in a line (row) as shown in, for example, FIGS. 4A and 4B. In FIG. 4A, the hinge portions 13 are disposed along an X-axis. Thus, the movable mirror portion 14 is tilted around the X-axis. In FIG. 4B, the hinge portions 13 are disposed along a Y-axis. Thus, the movable mirror portion 14 is tilted around the Y-axis. The movable mirror portions 14 shown in FIGS. 4A and 4B may be combined together.

It is unnecessary to dispose the plurality of through-holes 52 according to the present embodiment as described above. The single through-hole 52 may be disposed provided that the above-described junction can be achieved.

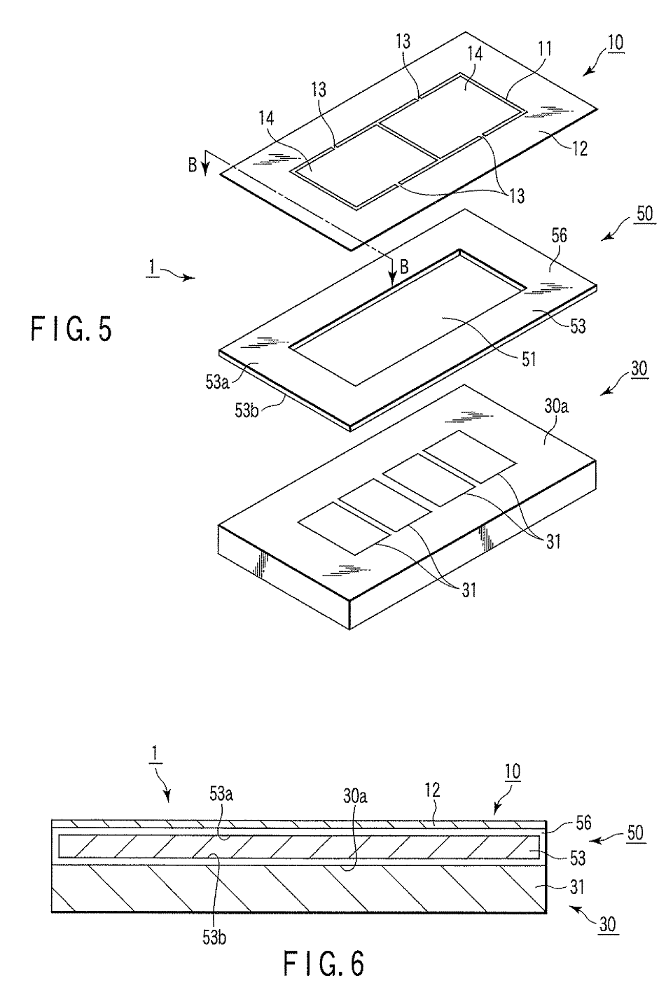

Now, a second embodiment will be described with reference to FIGS. 5 and 6. FIG. 5 is an exploded perspective view of a micromirror device according to the second embodiment of the present invention. FIG. 6 is a sectional view of the micromirror device shown in FIG. 5, taken along line B-B in FIG. 5, specifically, the view showing a junction in the micromirror device. The same components as those in the first embodiment, described above, are denoted by the same reference numbers and will not be described below in detail.

The micromirror chip 10 according to the present embodiment has a plurality of the movable mirror portions 14 disposed in a row as shown in FIG. 4A.

A plurality of the driving electrodes 31 are disposed in the electrode substrate 30 according to the present embodiment to the respective movable mirror portions 14.

The fixed member 53 according to the present embodiment has no through-hole 52 as shown in FIG. 6. A junction film 56 having uniform conductivity is formed on all surfaces of the fixed member 53 including the top surface 53a, lying opposite the mirror support portion 12, the bottom surface 53b, lying opposite the surface 30a, and all side surfaces contacting the top surface 53a and the bottom surface 53b. The junction film 56 is in contact with the mirror support portion 12 and the surface 30a. Thus, the mirror support portion 12 contacts the surface 30a via the junction film 56.

The junction film 56 is melted by the desired heating and weighting. In this case, the micromirror chip 10 and the intermediate spacer 50 (mirror support portion 12 and fixed member 53) are mechanically joined together. Furthermore, the intermediate spacer 50 and the electrode substrate 30 (fixed member 53 and surface 30a) are mechanically joined together. Thus, the micromirror chip 10 and the electrode substrate 30 are electrically connected together for electrical conduction.

The present invention is not limited to the above-described junction film 56. The junction film 56 has only to be formed on the top surface 53a, that is, a first surface lying opposite the mirror support portion 12, the bottom surface 53b, that is, a second surface lying opposite the surface 30a, and at least one surface contacting both the top surface 53a and the bottom surface 53b. The junction film 56 has only to electrically connect the micromirror chip 10 and the electrode substrate 30 together for electrical conduction and to join the micromirror chip 10 and the electrode substrate 30 together. The junction film 56 thus inhibits the mirror support portion 12 from being deformed to electrically connect the micromirror chip 10 and the electrode substrate 30 together for electrical conduction. Thus, the junction film 56 according to the present embodiment is an electrically conducting portion as is the case with the first embodiment and an inhibiting portion.

Now, the effects of the present embodiment will be described.

The junction film 56 touches on the surface 30a, and the intermediate spacer 50 is placed on the electrode substrate 30. The micromirror chip 10 touches on the junction film 56 and is placed on the intermediate spacer 50. When the micromirror chip 10, the electrode substrate 30, and the intermediate spacer 50 are thus stacked together, the movable mirror portion 14 lies opposite the driving electrodes 31 via the opening 51.

When the junction film 56 is melted by the desired heating and weighting, the micromirror chip 10 and the intermediate spacer 50 (mirror support portion 12 and fixed member 53) are joined together by the melted junction film 56. The intermediate spacer 50 and the electrode substrate 30 (fixed member 53 and electrode substrate 30) are jointed together by the melted junction film 56.

When the desired voltage is applied to the driving electrodes 31, electrostatic attraction is produced between the movable mirror portions 14 and the driving electrodes 31. Each of the movable mirror portions 14 is tilted through the desired angle by the electrostatic attraction using the hinge portions 13 as support points. In this case, stress is produced in the mirror support portion 12 via the hinge portions 13. That is, the tilt of the movable mirror portion 14 exerts pressure on the mirror support portion 12 via the hinge portions 13. In the present embodiment, the plurality of movable mirror portions 14 disposed exert a higher pressure on the mirror support portion 12 via the hinge portions 13 than the movable mirror portion 14 in the first embodiment. However, the mirror support portion 12, joined to the entire intermediate spacer 50 (top surface 52a) by the junction film 56, is inhibited from being displaced in the vertical direction. Consequently, a variation in gap is inhibited.

Thus, since the micromirror device 1 according to the present embodiment has the plurality of movable mirror portions 14, the mirror support portion 12 is subjected to a higher pressure via the hinge portions 13 than the mirror support portion 12 according to the first embodiment. However, in the present embodiment, the micromirror chip 10 and the intermediate spacer 50 are joined together by the junction film 56. Specifically, since the micromirror chip 10 is joined to the entire top surface 52a by the junction film 56, the junction is firmer than that in the first embodiment. Thus, the junction firmer than that in the first embodiment inhibits the micromirror chip 10 from being displaced in the vertical direction even with movement of the plurality of movable mirror portions 14.

Furthermore, even with the movement of the plurality of movable mirror portions 14, the junction inhibits the micromirror chip 10 from being displaced in the vertical direction. Thus, the present embodiment allows the gap to be determined on the basis of the thickness of the intermediate spacer 50 (fixed member 53). That is, adjustment of the thickness of the intermediate spacer 50 (fixed member 53) adjusts the gap.

Additionally, with the plurality of movable mirror portions 14 disposed, the present embodiment allows a variation in gap to be inhibited without being affected by the disposition condition of the movable mirror portions 14, for example, as shown in FIGS. 4A and 4B.

Even with only one movable mirror portion 14 disposed as in the case of the micromirror device 1 according to the first embodiment, the present embodiment can exert effects similar to those described above.

The junction film 56 according to the present embodiment can be incorporated into the first embodiment. In this case, the junction film 56 may be responsible for only one of the junction and the electrical conduction. The junction refers to the junction between the micromirror chip 10 and the intermediate spacer 50 and the junction between the intermediate spacer 50 and the electrode substrate 30. The electrical conduction refers to the electrical conduction between the micromirror chip 10 and the electrode substrate 30.

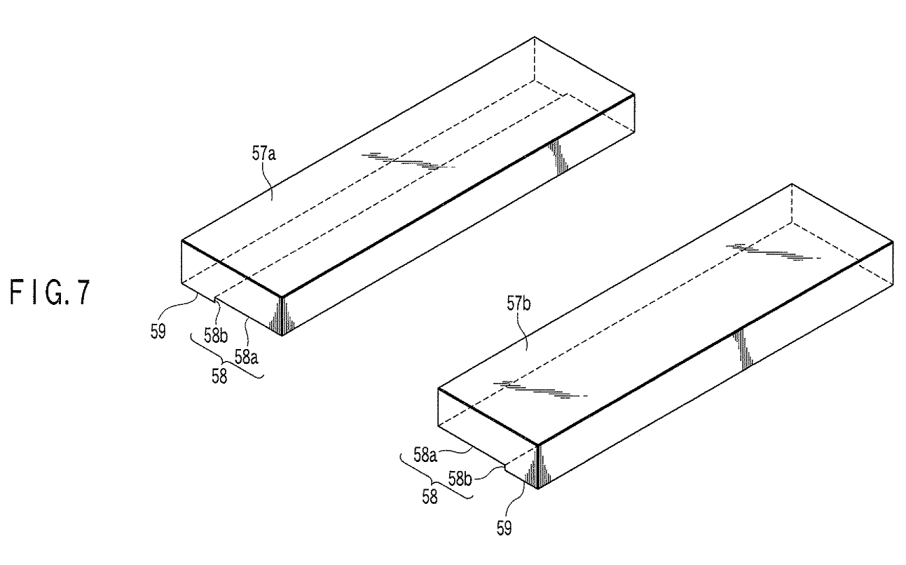

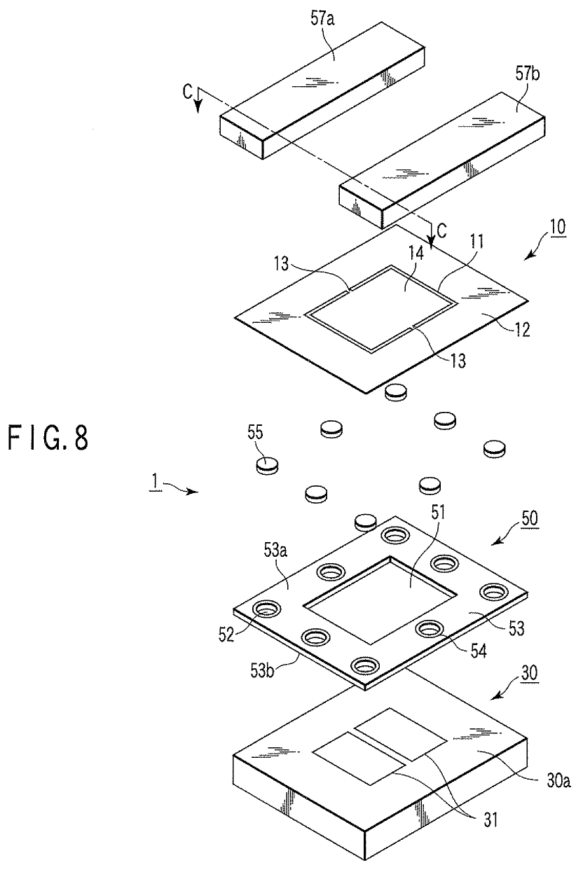

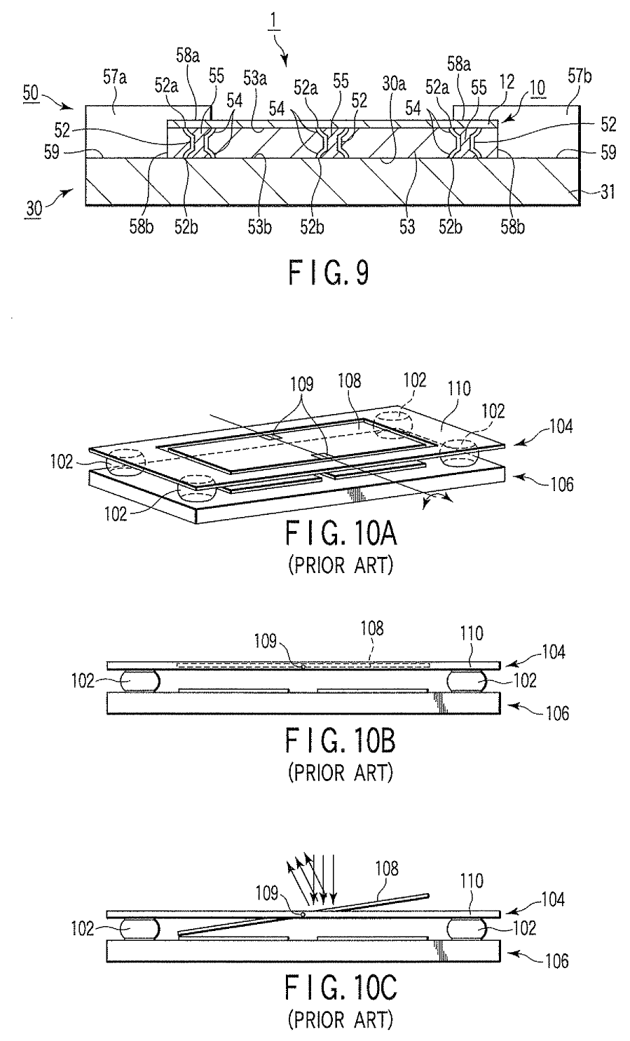

Now, a third embodiment will be described with reference to FIGS. 7 to 9. FIG. 7 is a schematic perspective view of a frame member according to the third embodiment of the present invention. FIG. 8 is an exploded perspective view of a micromirror device according to the third embodiment of the present invention. FIG. 9 is a sectional view of the micromirror device shown in FIG. 8, taken along line C-C in FIG. 8, specifically, the view showing a junction in the micromirror device. The same components as those in the first embodiment, described above, are denoted by the same reference numbers and will not be described below in detail. The micromirror chip 10, the intermediate spacer 50, and the electrode substrate 30 are substantially the same as those in the first embodiment.

The micromirror device 1 according to the present embodiment has two substantially reshaped frame members 57a and 57b. The frame members 57a and 57b are located opposite the micromirror chip 10 (mirror support portion 12) in the stacking direction, opposite the intermediate spacer 50 (top surface 53a), that is, an intermediate member, via the micromirror chip 10 in the stacking direction, and opposite side surfaces of the micromirror chip 10 and side surfaces of the intermediate spacer 50, that is, the intermediate member. The frame members 57a and 57b inhibit the vertical displacement of the micromirror chip 10 (mirror support portion 12) via the micromirror chip 10 and the intermediate spacer 50 (mirror support portion 12 and fixed member 53).

The frame members 57a and 57b have a material that is more rigid than the mirror support portion 12 and are each thicker than the mirror support portion 12. Each of the frame members 57a and 57b has a notch 58. The notch 58 has a notch surface 58a that tightly touches on the mirror support portion 12 and a notch surface 58b that tightly touches on the side surface of the micromirror chip 10 and the side surface of the intermediate spacer 50. The notch surface 58a has only to touch on the mirror support portion 12 and does not touch on the opening 11.

In the present embodiment, the surface 30a is larger than the bottom surface 53b. A bottom surface 59 of each of the frame members 57a and 57b tightly touches on the surface 30a. The surface 30a may have substantially the same area as that of the bottom surface 53b. In this case, the notch surface 58b has only to tightly touch on the side surfaces of the micromirror chip 10, the electrode substrate 30, and the intermediate spacer 50.

Now, the effects of the present embodiment will be described.

When the junction member 55 is melted by the desired heating and weighting as is the case with the first embodiment, described above, the melted junction member 55 joins the micromirror chip 10 and the intermediate spacer 50 (mirror support portion 12 and fixed member 53) together and also joins the intermediate spacer 50 and the electrode substrate 30 (fixed member 53 and electrode substrate 30) together.

In this condition, the bottom surfaces 59 of the frame members 57a and 57b touch on the surface 30a. The notch surface 58b tightly touch on the side surface of the micromirror chip 10 and the side surface of the intermediate spacer 50. The notch surface 58a tightly touches on the mirror support portion 12.

When the desired voltage is applied to the driving electrodes 31, electrostatic attraction is produced between the movable mirror portion 14 and the driving electrodes 31. The movable mirror portion 14 is tilted through the desired angle by the electrostatic attraction using the hinge portions 13 as support points. In this case, stress is produced in the mirror support portion 12 via the hinge portions 13. That is, the tilt of the movable mirror portion 14 exerts pressure on the mirror support portion 12 via the hinge portions 13. However, the mirror support portion 12, joined to the fixed member 53 by the junction member 55, is inhibited from being displaced in the vertical direction. The mirror support portion 12 is also inhibited from vertical displacement by the frame members 57a and 57b. Consequently, a variation in gap is inhibited.

Thus, the present embodiment exerts effects similar to those of the first embodiment, described above. Even with movement of the movable mirror portions 14, the micromirror chip 10 is inhibited from vertical displacement by the frame members 57a and 57b. Thus, the present embodiment can further inhibit a variation in gap.

Furthermore, even if for example, the junction member 55 is degraded and the junction between the micromirror chip 10 and the intermediate spacer 50 (mirror support portion 12 and fixed member 53) is thus degraded, the present embodiment can inhibit a variation in gap using the frame members 57a and 57b.

In the present embodiment, the micromirror device 1 has the two frame members 57a and 57b. However, the number of the frame members need not be limited. For example, the single frame member 57 may be used for the inhibition. Furthermore, the micromirror device may be inhibited from displacement by four frame members 57 corresponding to all the sides of the micromirror chip 10 and the intermediate spacer 50.

Additionally, the frame members 57 according to the present embodiment can be incorporated into the second embodiment.

The present invention is not limited to the as-described embodiments. In implementation, the components of the embodiments may be varied without departing from the spirit of the present invention. Furthermore, various inventions can be formed by appropriately combining a plurality of the components disclosed in the above-described embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A micromirror device comprising:
a first member having a movable portion and a movable portion support portion which supports the movable portion;
a second member having a driving electrode to which a driving voltage allowing the movable portion to move is applied; and
an intermediate member sandwiched between the first member and second member,
wherein the intermediate portion has:
an electrically conducting portion which electrically connects the first member and the second member together for electrical conduction;
a spacer portion which holds a desired distance between the first member and the second member; and
an inhibiting portion which inhibits the first member from being deformed.

2. The micromirror device according to claim 1, wherein the first member has substantially the same thickness as that of the movable portion.

3. The micromirror device according to claim 2, wherein the intermediate portion has:
a plate-like member having substantially the same shape as that of the movable support portion and having a through-hole which penetrates the plate-like member in a thickness direction, the plate-like member including the spacer portion; and
a junction member inserted and placed in the through-hole to electrically connect the first member and the second member together for electrical conduction and to join the first member and the second member together, the junction member having an electrically conducting portion, and
the plate-like member and the junction member has the inhibiting portion.

4. The micromirror device according to claim 3, wherein a clearance groove is formed on a surface of the through-hole which lies opposite the first member and the second member.

5. The micromirror device according to claim 4, further comprising a frame member located opposite the intermediate member to inhibit vertical displacement of the movable portion support portion via the movable support member and the intermediate member.

6. The micromirror device according to claim 2, wherein the intermediate portion has:
a plate-like member having substantially the same shape as that of the movable support portion and including the spacer portion; and
a film formed on a first surface located opposite the movable portion support portion, a second surface located opposite the second member, and at least one side surface contacting both the first surface and the second surface, the film electrically connecting the first member and the second member together for electrical conduction and joining the first member and the second member, the film also having the electrically conducting portion and the inhibiting portion.

7. The micromirror device according to claim 6, further comprising a frame member located opposite the intermediate member to inhibit vertical displacement of the movable portion support portion via the movable support member and the intermediate member.

8. The micromirror device according to claim 1, wherein the first member has a plurality of the movable portions disposed in a row.

9. The micromirror device according to claim 8, wherein the intermediate portion has:
a plate-like member having substantially the same shape as that of the movable support portion and having a through-hole which penetrates the plate-like member in a thickness direction, the plate-like member including the spacer portion; and
a junction member inserted and placed in the through-hole to electrically connect the first member and the second member together for electrical conduction and to join the first member and the second member together, the junction member having an electrically conducting portion, and
the plate-like member and the junction member has the inhibiting portion.

10. The micromirror device according to claim 9, wherein a clearance groove is formed on a surface of the through-hole which lies opposite the first member and the second member.

11. The micromirror device according to claim 10, further comprising a frame member located opposite the intermediate member to inhibit vertical displacement of the movable portion support portion via the movable support member and the intermediate member.

12. The micromirror device according to claim 8, wherein the intermediate portion has:
a plate-like member having substantially the same shape as that of the movable support portion and including the spacer portion; and
a film formed on a first surface located opposite the movable portion support portion, a second surface located opposite the second member, and at least one side surface contacting both the first surface and the second surface, the film electrically connecting the first member and the second member together for electrical conduction and joining the first member and the second member, the film also having the electrically conducting portion and the inhibiting portion.

13. The micromirror device according to claim 12, further comprising a frame member located opposite the intermediate member to inhibit vertical displacement of the movable portion support portion via the movable support member and the intermediate member.

14. The micromirror device according to claim 1, wherein the intermediate portion has:
a plate-like member having substantially the same shape as that of the movable support portion and having a through-hole which penetrates the plate-like member in a thickness direction, the plate-like member including the spacer portion; and
a junction member inserted and placed in the through-hole to electrically connect the first member and the second member together for electrical conduction and to join the first member and the second member together, the junction member having an electrically conducting portion, and the plate-like member and the junction member has the inhibiting portion.

15. The micromirror device according to claim 14, wherein a clearance groove is formed on a surface of the through-hole which lies opposite the first member and the second member.

16. The micromirror device according to claim 15, further comprising a frame member located opposite the intermediate member to inhibit vertical displacement of the movable portion support portion via the movable support member and the intermediate member.

17. The micromirror device according to claim 1, wherein the intermediate portion has:
a plate-like member having substantially the same shape as that of the movable support portion and including the spacer portion; and
a film formed on a first surface located opposite the movable portion support portion, a second surface located opposite the second member, and at least one side surface contacting both the first surface and the second surface, the film electrically connecting the first member and the second member together for electrical conduction and joining the first member and the second member, the film also having the electrically conducting portion and the inhibiting portion.

18. The micromirror device according to claim 17, further comprising a frame member located opposite the intermediate member to inhibit vertical displacement of the movable portion support portion via the movable support member and the intermediate member.
